(19) United States
(12) Patent Application Publication
(10) Pub. No.: US 2013/0165562 A1
(43) Pub. Date: Jun. 27, 2013

(54) PHOSPHOROUS FLAME RETARDANT CONTAINING CLAY

(71) Applicants: Jiang-Jen Lin, Taipei (TW); Ting-Kai Huang, Taipei (TW)

(72) Inventors: Jiang-Jen Lin, Taipei (TW); Ting-Kai Huang, Taipei (TW)

(73) Assignee: NATIONAL TAIWAN UNIVERSITY, Taipei (TW)

(21) Appl. No.: 13/561,054

(22) Filed: Jul. 29, 2012

(30) Foreign Application Priority Data
Dec. 23, 2011 (TW) 100148407

(51) Int. Cl. C09K 21/12; C08L 21/00; C08L 75/04; C08K 3/34; C08K 5/5399

(52) U.S. Cl. 524/116; 252/609

(57) ABSTRACT

A phosphorous flame retardant containing clay is made in two steps. First, chlorines of hexachlorocyclotriphosphazene (HCP) are substituted with poly(oxyalkylene)-amines in the replacement reaction. Layered or exfoliated clay are then added to perform the intercalation, exfoliation or adsorption reaction to produce the phosphorous flame retardant. The phosphorous flame retardant can be further mixed with a polymer to promote the flame-retarding effect of the polymer.

### BACKGROUND OF THE INVENTION

1. Field of the Invention

The present invention relates to a phosphorous flame retardant, and particularly to a phosphorous flame retardant containing clay, which can be used in materials for polymer, electronic components and parts, semiconductor packaging, buildings, etc.

2. Related Prior Arts

For general plastics, the flame retardant is usually added in a content about 10% to 30%. If the flame retardant is organic, higher contents do not facilitate flame-retarding effect but lower mechanic properties. If the flame retardant is inorganic, the flame-retarding effect may be promoted by increasing its content but the plastics will be brittle, opaque and permeable by oil or wax.

To overcome the above problems, the present invention discloses a flame retardant containing organic and inorganic components in certain ratios. The flame retardant can effectively promote the flame-retarding effect of polymers at lower contents than conventional flame retardants.

### SUMMARY OF THE INVENTION

The main object of the present invention is to provide a flame retardant containing clay and a method for producing the same. The flame retardant containing clay can reduce decomposition of polymers in flame or high temperatures.

In the present invention, poly(oxyalkylene)amine reacts with hexachlorocyclotriphosphazene (HCP) to produce AP-poly(oxyalkylene)amine. The acidified AP-poly(oxyalkylene)amine is a complex with both hydrophilic and hydrophobic properties and can intercalate the layered clay and even fully exfoliate it. Since the modified or exfoliated clay has a good dispersing ability in polymers, AP-poly(oxyalkylene)amine can also be uniformly dispersed in polymers to promote the flame-retarding effect thereof. Clay is also known as a good flame retardant, so the flame-retarding effect will be even better by mixing with AP-poly(oxyalkylene)amine. Tests show that the composite of AP-poly(oxyalkylene)amine and clay of the present invention could increase residual carbon contents of TPU to about 30% at 400° C.

The process for producing the phosphorous flame retardant containing clay and the application thereof to form a flame-retarding polymer are shown in FIG. 1.

The method for producing the phosphorous flame retardant containing clay primarily includes steps of:
(a) mixing hexachlorocyclotriphosphazene (HCP) and poly(oxyalkylene)amine to perform a replacement reaction at a reaction temperature ranging from 0° C. to 200° C. so that all chlorines of HCP are replaced with poly(oxyalkylene)amine and AP-poly(oxyalkylene)amine (or named as HCP-poly(oxyalkylene)amine) is produced; and
(b) mixing AP-poly(oxyalkylene)amine of step (a) with natural or synthetic inorganic layered clay or fully exfoliated clay so that the AP-poly(oxyalkylene)amine intercalates or exfoliates the inorganic layered clay or adsorbs on surfaces of the fully exfoliated clay to produce the phosphorous flame retardant containing clay.

In the above step (a), the replacement reaction can be performed with or without an alkaline. The alkaline can be organic or inorganic and includes, but is not limit to, calcium carbonate, sodium hydroxide and triethylamine (TEA). The replacement reaction can be performed with or without a solvent, which is preferably an organic solvent containing, but not limiting to, tetrahydrofuran (THF) and monochlorobenzene (MCB). The HCP and poly(oxyalkylene)amine of step (a) have an equivalent ratio of 1:6 to 1:12, preferably 1:6 to 1:10, and more preferably 1:6 to 1:8. After the replacement reaction is completed, the AP-poly(oxyalkylene)amine is preferably further filtered to remove the organic or inorganic salt. The poly(oxyalkylene)amine is preferably poly(oxyalkylene)-monoamine, and more preferably the hydrophilic poly(oxyethylene)-monoamine. The reaction temperature is preferably 60 to 150° C., and more preferably 90 to 130° C.

In the above step (b), the clay can be montmorillonite, mica, bentonite, etc. The AP-poly(oxyalkylene)amine can be alternatively acidified to form a complex by adding an organic or inorganic acid prior to exfoliating the clay. The organic acid is preferably acetic acid, and the inorganic acid is preferably hydrochloric acid or para-toluenesulfonic acid (PTSA). The acid is preferably has an equivalent 0.1 to 12. Then the natural or synthetic inorganic layered clay is added to perform an exfoliation reaction to produce a composite of AP-poly(oxyalkylene)amine/exfoliated clay. The AP-poly(oxyalkylene)amine and the acid preferably have an equivalent ratio 1:6 to 1:20, and more preferably 1:6 to 1:15. The AP-poly(oxyalkylene)amine and the clay preferably have an equivalent 1:3 to 1:20, and more preferably 1:3 to 1:15. The exfoliation reaction is preferably performed in a solvent, which can be water soluble, water insoluble or water.

According to the above method, the phosphorous flame retardant containing clay will include a composite of AP-poly(oxyalkylene)amine and clay, wherein the clay, AP-poly(oxyalkylene)amine and equivalent ratio thereof are defined as the above.

Furthermore, a flame-retarding polymer can be produced in a further step:
(c) mixing the phosphorous flame retardant containing clay into a polymer. The process of mixing can be made by any general process and is not limited to any particular one. A solvent, for example, dimethylformamide (DMF), can be used, but other solvents may be used.

The flame-retarding polymer primarily includes a mixture of the phosphorous flame retardant containing clay and the polymer wherein the polymer is preferably but not limited to thermoplastic polyurethane (TPU) or thermoplastic rubber (TPR). In the flame-retarding polymer, the phosphorous flame retardant containing clay and the polymer preferably have a weight ratio 1:15.4 to 1:3.5, and more preferably 1:10 to 1:5. The product can be further dried and formed as a membrane or film through proper processes such as blending and compressing.

### BRIEF DESCRIPTION OF THE DRAWINGS

FIG. 1 shows the process for producing the phosphorous flame retardant containing clay and the application thereof to make a flame-retarding polymer.

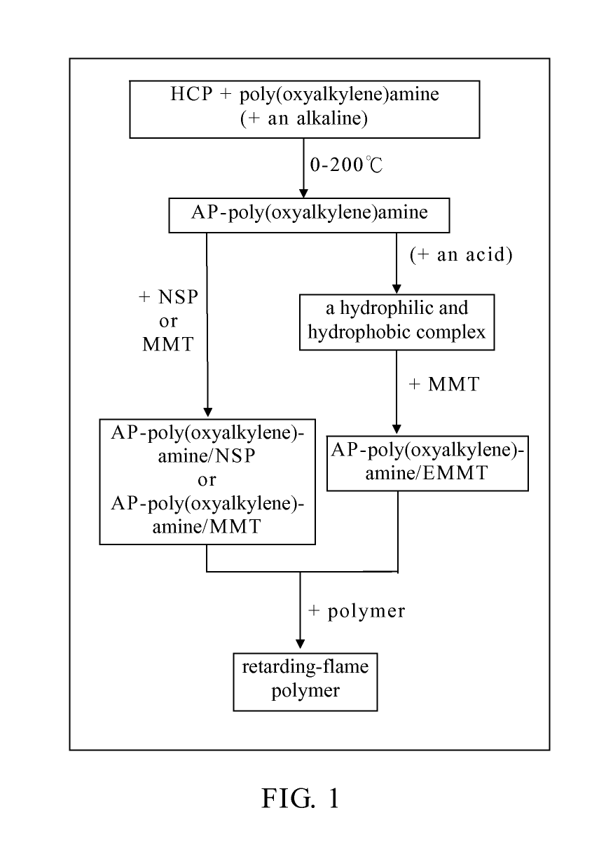

FIG. 2 shows the results from the thermogravity analysis (TGA) of the membranes of Examples 1 to 3 and Comparative Examples 1 to 3.

### DETAILED DESCRIPTION OF THE PREFERRED EMBODIMENTS

The materials used in the following Examples and Comparative Examples include:
1. Hexachlorocyclotriphosphazene (HCP): Mw=347.6 g/mole, merchandized from Kuo Ching Chemical Co., Ltd, directly applied or dissolved in a solvent before use.
2. Poly(oxypropylene)-poly(oxyethylene)-amines: merchandized from Hunstsman Chemical Co.; hydrophilic monoamines having trademark JEFFAMINE® M-amine series containing M-600, M-1000, M-2005 and M-2070 are used; M-600 and M-2005 have polypropylene glycol (PPG) segments or polyoxypropylene (OP) segments as the backbones, and M-1000 and M-2070 have polyethylene glycol (PEG) segments or polyoxyethylene (OP) segments as the backbones which are more hydrophilic than M-600 and M-2005 and have structural formula as follows:

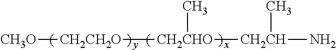

| y/x | M-amine | Mw |
|---|---|---|
| 1/9 | M600 | 600 |
| 19/3 | M1000 | 1010 |
| 6/39 | M2005 | 2100 |
| 32/10 | M2070 | 2200 |

y/x: molar ratio of EO/PO (ethylene oxide/propylene oxide)

3. Montmorillonite (Na⁺-MMT): cationic exchanging capacity (CEC)=120 mequiv/100 g, merchandized from Nanocor Co., trademark PGW®.
4. Nanosilicate plate (NSP): in the form of individual platelets or layer exfoliated from layered clay such as Na⁺-montmorillonite (Na⁺-MMT) or mica; merchandized from JJ Nano Co. (10 wt % in water); CEC=1.2 meq/g, aspect ratio about 80×80×1 to 120×120×1 nm³ with an average of about 100×100×1 nm³; surface area about 700 to 800 m²/g; ionic charge density about 18,000 to 20,000 ions/platelet; about 4×10¹⁶ platelets/g; isoelectric point (IEP) in water at pH=6.4; rearranging when being dispersed in a solution, for example, dual layers or platelets as a structural unit. In some Examples of this specification, MMT is directly exfoliated with acidified AP-poly(oxyalkylene)amine through a similar process, and the product is named as “EMMT”.
5. Thermoplastic polyurethane (TPU): merchandized from Kuo Ching Chemical Co., Ltd, copolymer of polybutester, butanediol and MDI, with hardness Shore Hardness 85 A.
6. Thermoplastic rubber (TPR): merchandized from Kuo Ching Chemical Co., Ltd, with hardness Shore Hardness 85 A.
7. Tetrahydrofuran (THF): for dissolving HCP.
8. Dimethylformamide (DMF): for dissolving TPU.
9. Calcium carbonate, sodium hydroxide and triethylamine (TEA): for removing hydrochloric acid generated during reaction.
10.Hydrochloric acid, para-toluenesulfonic acid (PTSA) and acetic acid (AA): for acidifying AP-poly(oxyalkylene)amine in the process of exfoliating MMT.
11. Monochlorobenzene (MCB): for synthesizing poly(oxyalkylene)amine and HCP or exfoliating clay.

Detailed procedures are described as follows, wherein Examples 1 and 4-5 use AP-poly(oxyalkylene)amine to exfoliate MMT, Example 2 uses AP-poly(oxyalkylene)amine to adsorb NSP, and Examples 3 and 6 use AP-poly(oxyalkylene)amine to intercalate MMT. Operating conditions for steps (a), (b) and (c) are listed in Tables 1, 2 and 3, respectively.

TABLE 1
Operating conditions for step (a): replacement reaction

| | | | | Reac- | | |
|---|---|---|---|---|---|---|
| | | | | tion | Reac- | |
| | | | Poly(oxy- | tem- | tion | |
| Ex- | Alkaline | HCP | alkylene)amine | perature | time | |
| ample | (eq) | (eg) | (eq) | (° C.) | (hour) | Product |
| 1-3 | calcium | 1 | M1000 (7) | 180 | 4 | AP-M1000 |
| | carbonate (8) | | | | | |
| 4 | NaOH (8) | 1 | M600 (12) | 140 | 24 | AP-M600 |
| 5 | TEA (7) | 1 | M2005 (7) | 60 | 48 | AP-M2050 |
| 6 | — | 1 | M2070 (6) | 200 | 6 | AP-M2070 |

TABLE 2
Operating conditions for step (b) for forming the flame retardant

| | | | | Reac- | | |
|---|---|---|---|---|---|---|
| | | | | tion | Reac- | |
| | AP-poly(oxy- | | | tem- | tion | |
| Ex- | alkylene)amine | Acid | Clay | perature | time | |
| ample | (eq) | (eq) | (eq) | (° C.) | (hour) | product |
| 1 | AP-M1000 (1) | hydro- | MMT | Room | 1 | AP-M1000/ |
| | | chloric | (12) | tem- | | EMMT |
| | | acid (12) | | perature | | |
| 2 | AP-M1000 (1) | — | NSP | 60 | 1 | AP-M1000/ |
| | | | (12) | | | NSP |
| 3 | AP-M1000 (1) | — | MMT | 60 | 1 | AP-M1000/ |
| | | | (12) | | | MMT |
| 4 | AP-M600 (1) | PTSA (6) | MMT | Room | 1 | AP-M600/ |
| | | | (6) | tem- | | EMMT |
| | | | | perature | | |
| 5 | AP-M2005 (1) | Acetic acid | MMT | Room | 1 | AP-M2005/ |
| | | (10) | (3) | tem- | | EMMT |
| | | | | perature | | |
| 6 | AP-M2070 (1) | — | MMT | 60 | 1 | AP-M2070/ |
| | | | (3) | | | MMT |

TABLE 3
Operating conditions for step (c) for forming flame-retarding polymers

| Example/ | AP-poly(oxy- | | |
|---|---|---|---|
| Comparative | alkylene)amine/ | | |
| Example | clay (g) | Polymer | Product |
| Example 1 | AP-M1000/EMMT | TPU (77 g) | AP-M1000/EMMT/TPU |
| | (0.94) | | |
| Example 2 | AP-M1000/NSP | TPU (77 g) | AP-M1000/NSP/TPU |
| | (0.94) | | |
| Example 3 | AP-M1000/MMT | TPU (77 g) | AP-M1000/MMT/TPU |
| | (0.94) | | |
| Example 4 | AP-M600/EMMT | TPU (77 g) | AP-M600/EMMT/TPU |
| | (0.5) | | |
| Example 5 | AP-M2005/EMMT | TPR (7.7 g) | AP-M2005/EMMT/TPR |
| | (2) | | |
| Example 6 | AP-M2070/MMT | TPU (77 g) | AP-M2070/MMT/TPU |
| | (2.2) | | |
| Comparative | AP-M1000 | TPU (77 g) | AP-M1000/TPU |
| Example 1 | (0.63 g) | | |
| Comparative | MMT | TPU (77 g) | MMT/TPU |
| Example 2 | (0.31 g) | | |
| Comparative | NSP | TPU (77 g) | NSP/TPU |
| Example 3 | (0.31 g) | | |

TPU: having a solid content of 10 wt % in DMF

### Example 1

### Preparing the AP-M1000/EMMT/PU Membrane

### Step (a) Synthesizing AP-M1000

In the presence of calcium carbonate (8 eq), HCP (1 eg) and M1000 (7 eq) were heated to 180t and the reaction time was 4 hours. After the reaction was completed, the heated mixture was filtered to remove inorganic salts. AP-M1000 (or HCP-M1000, hereinafter the abbreviations AP and HCP in the similar context are synonymous) was produced.

### Step (b) Synthesizing the Flame Retardant AP-M1000/EMMT

AP-M1000 (1 eq) was dissolved in methanol and acidified by adding hydrochloric acid (12 eq) to form a complex. MMT (12 eq) was then added for ion exchanging reaction. The reaction time was 1 hour. The product (AP-M1000/EMMT composite) was analyzed with X-ray Diffraction (XRD) to confirm that the EMMT was in the form of exfoliated nanosilicate platelets.

### Step (c) Forming the AP-M1000/EMMT/TPU Membrane

AP-M1000/EMMT (0.94 g) was added into TPU solution (77 g, solid content 10 wt % in DMF). The mixture was mixed at room temperature for 10 minutes and then dried on a substrate to form the AP-M1000/EMMT/TPU membrane.

### Example 2

### Preparing the AP-M1000/NSP/TPU Membrane

Steps (a) to (c) of Example 1 were repeated, except that in Step (b), AP-M1000 (1 eq) dissolved in methanol was directly mixed with NSP (12 eq) at 60° C. for 1 hours to produce the flame retardant AP-M1000/NSP, and in Step (c), AP-M1000/EMMT (0.94 g) was replaced with AP-M1000/NSP (0.94 g) to produce the AP-M1000/NSP/TPU membrane.

### Example 3

### Preparing the AP-M1000/MMT/TPU Membrane

Steps (a) to (c) of Example 1 were repeated, except that in Step (b), AP-M1000 (1 eq) dissolved in methanol was directly mixed with MMT (12 eq) at 60° C. for 1 hours to produce the flame retardant AP-M1000/MMT, and in Step (c), AP-M1000/EMMT (0.94 g) was replaced with AP-M1000/MMT (0.94 g) to produce the AP-M1000/MMT/TPU membrane.

### Example 4

### Preparing the AP-M600/EMMT/TPU Membrane

### Step (a) Synthesizing AP-M600

In the presence of sodium hydroxide (8 eq), HCP (1 eg) and M600 (7 eq) were heated to 140° C. and the reaction time was 24 hours. After the reaction was completed, the heated mixture was filtered to remove inorganic salts. AP-M600 was produced.

### Step (b) Synthesizing the Flame Retardant AP-M600/EMMT

AP-M600 (1 eq) was dissolved in toluene and acidified by adding PTSA (6 eq) to form a complex. MMT (6 eq) was then added for ion exchanging reaction. The reaction time was 1 hour. The product (AP-M600/EMMT composite) was analyzed with X-ray Diffraction (XRD) to confirm that the EMMT was in the form of exfoliated nanosilicate platelets.

### Step (c) Forming the AP-M600/EMMT/TPU Membrane

AP-M600/EMMT (0.5 g) was added into TPU solution (77 g, solid content 10 wt % in DMF). The mixture was mixed at room temperature for 10 minutes and then dried on a substrate to form the AP-M600/EMMT/TPU membrane.

### Example 5

### Preparing the AP-M2005/EMMT/TPR Membrane

### Step (a) Synthesizing AP-M2005

In the presence of TEA (7 eq), HCP (1 eg) and M2005 (7 eq) were heated to 60° C. in THF and the reaction time was 48 hours. After the reaction was completed, the heated mixture was filtered to remove organic salts. AP-M2005 was produced.

Step (b) Synthesizing the Flame Retardant AP-M2005/EMMT

AP-M2005 (1 eq) was dissolved in toluene and acidified by adding acetic acid (10 eq) to form a complex. MMT (3 eq) was then added for ion exchanging reaction. The reaction time was 1 hour. The product (AP-M2005/EMMT composite) was analyzed with X-ray Diffraction (XRD) to confirm that the EMMT was in the form of exfoliated nanosilicate platelets.

### Step (c) Forming the AP-M2005/EMMT/TPR Membrane

AP-M2005/EMMT (2.0 g) was added into TPR (7.7 g). The mixture was blended at 220° C. for 10 minutes and then compressed in a mold to form the AP-M2005/EMMT/TPR membrane.

### Example 6

### Preparing the AP-M2070/MMT/TPU Membrane

### Step (a) Synthesizing AP-M2070

In protection of the nitrogen gas, HCP (1 eg) and M2070 (6 eq) were heated to 200° C. and the reaction time was 6 hours. After the reaction was completed, the heated mixture was filtered to remove organic salts. AP-M2070 was produced.

### Step (b) Synthesizing the Flame Retardant AP-M2070/MMT

AP-M2070 (1 eq) was mixed with MMT (3 eq) in water at 60° C. for 1 hour. The MMT was intercalated with AP-M2070 and the flame retardant AP-M2070/MMT was produced.

### Step (c) Forming the AP-M2070/MMT/TPU Membrane

AP-M2070/MMT (2.2 g) was added into TPU solution (77 g, solid content 10 wt % in DMF). The mixture was mixed at room temperature for 10 minutes and then dried on a substrate to form the AP-M2070/MMT/TPU membrane.

### Comparative Example 1

### Preparing the AP-M1000/PU Membrane

Steps (a) and (c) of Example 1 were repeated, except that, in Step (c), AP-M1000/EMMT (0.94 g) was replaced with AP-M1000 (0.63 g).

### Comparative Example 2

### Preparing the MMT/TPU Membrane

Step (c) of Example 1 was repeated, except that AP-M1000/EMMT (0.94 g) was replaced with MMT (0.31 g).

### Comparative Example 3

### Preparing the NSP/TPU Membrane

Step (c) of Example 1 was repeated, except that AP-M1000/EMMT (0.94 g) was replaced with NSP (0.31 g).

### Thermogravity Analysis (TGA)

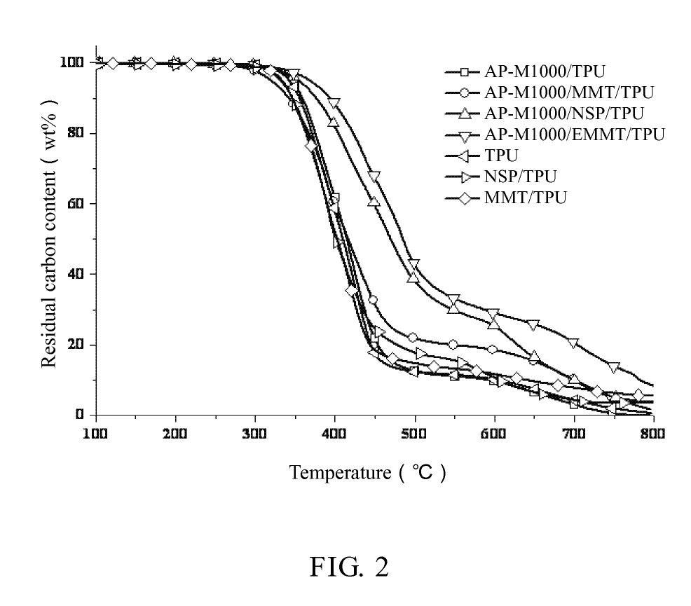

The membranes of Examples 1-3 and Comparative Examples 1-3 were analyzed. FIG. 2 shows the results. At 500° C., TPU of Examples 1, 2 and 3 had residual carbon contents of respectively 45%, 40% and 22%, which were higher than pure TPU (residual carbon content 11%) by 11% to 34%. The TPU of Comparative Examples 1 to 3 had residual carbon contents of respectively 18%, 15% and 12%, which were lower than those of Examples 1 to 3. The results confirm that TPU can effectively retard flame by adding the composite of AP-poly(oxyalkylene)amine with clay, and particularly with the exfoliated clay.

In addition to TPU and TPR, effects of the flame retardant of the present invention can be applied to other materials in practice. For example, the materials for electronic components and parts, semiconductor packaging and buildings can be mixed with the flame retardant of the present invention to form flame-retarding articles.

1. A method for producing a phosphorous flame retardant containing clay, comprising steps of:
(a) mixing hexachlorocyclotriphosphazene (HCP) and poly(oxyalkylene)amine to perform a replacement reaction at a reaction temperature ranging from 0° C. to 200° C. so that all chlorines of HCP are replaced with poly(oxyalkylene)amine to form AP-poly(oxyalkylene)amine (or HCP-poly(oxyalkylene)amine); and
(b) mixing the AP-poly(oxyalkylene)amine of step (a) with a natural or synthetic inorganic layered clay or a fully exfoliated clay so that the AP-poly(oxyalkylene)amine intercalates or exfoliates the inorganic layered clay or adsorbs on surfaces of the fully exfoliated clay to produce the phosphorous flame retardant containing clay.

2. The method of claim 1, wherein the replacement reaction of step (a) is performed in the presence of an alkaline.

3. The method of claim 1, wherein the replacement reaction of step (a) is performed in the absence of an alkaline.

4. The method of claim 1, wherein the replacement reaction of step (a) is performed in tetrahydrofuran (THF) or monochlorobenzene (MCB).

5. The method of claim 1, wherein the HCP and poly(oxyalkylene)amine of step (a) have an equivalent ratio of 1:6 to 1:12.

6. The method of claim 1, wherein the HCP and poly(oxyalkylene)amine of step (a) have an equivalent ratio of 1:6 to 1:10.

7. The method of claim 1, wherein AP-poly(oxyalkylene)amine of step (a) is further filtered after the replacement reaction is completed.

8. The method of claim 1, wherein the AP-poly(oxyalkylene)amine of step (b) is acidified to form a complex by first adding an organic or inorganic acid prior to exfoliating the natural or synthetic inorganic layered clay.

9. The method of claim 7, wherein the AP-poly(oxyalkylene)amine and the acid of step (b) have an equivalent ratio of 1:6 to 1:20.

10. The method of claim 1, wherein the AP-poly(oxyalkylene)amine and the clay of step (b) have an equivalent of 1:3 to 1:20.

11. The method of claim 1, wherein the AP-poly(oxyalkylene)amine and the clay of step (b) have an equivalent of 1:3 to 1:15.

12. A phosphorous flame retardant containing clay, comprising a composite of AP-poly(oxyalkylene)amine and clay, wherein
the clay is a natural or synthetic inorganic layered clay intercalated or exfoliated by AP-poly(oxyalkylene)amine, or a fully exfoliated clay having AP-poly(oxyalkylene)amine adsorbed on surfaces or within layers thereof; and
AP-poly(oxyalkylene)amine is a compound of hexachlorocyclotriphosphazene (HCP) with poly(oxyalkylene)amine substituting all chlorines.

13. The phosphorous flame retardant containing clay of claim 12, wherein the AP-poly(oxyalkylene)amine and the clay have an equivalent ratio of 1:3 to 1:20.

14. A retarding-flame polymer, comprising a mixture of the phosphorous flame retardant containing clay of claim 12 and a polymer.

15. The retarding-flame polymer of claim 14, wherein the polymer is thermoplastic polyurethane (TPU) or thermoplastic rubber (TPR).

16. The retarding-flame polymer of claim 14, wherein the phosphorous flame retardant containing clay and the polymer have a weight ratio 1:15.4 to 1:3.5.

17. The retarding-flame polymer of claim 14, wherein the phosphorous flame retardant containing clay and the polymer have a weight ratio 1:10 to 1:5.
